(19) United States
(12) Patent Application Publication
(10) Pub. No.: US 2008/0043943 A1
(43) Pub. Date: Feb. 21, 2008

(54) GRAPHICAL USER INTERFACE FOR CREATING AND ACCESSING VOICE MESSAGES

(75) Inventors: Joseph K. Sipher, Sunnyvale, CA (US); Jocelyn F. Cloutier, Menlo Park, CA (US); Dimitre T. Piskyulev, Santa Clara, CA (US); Eric F.H. Chun, San Jose, CA (US); Michael Koon-Huat Ang, San Jose, CA (US)

Correspondence Address: WORKMAN NYDEGGER, 60 EAST SOUTH TEMPLE, 1000 EAGLE GATE TOWER, SALT LAKE CITY, UT, 84111, US

(73) Assignee: Pinger, Inc., San Jose, CA (US)

(21) Appl. No.: 11/842,910

(22) Filed: Aug. 21, 2007

Related U.S. Application Data
(60) Provisional application No. 60/823,065, filed on Aug. 21, 2006.

(51) Int. Cl. H04M 1/64

(52) U.S. Cl. 379/88.22

(57) ABSTRACT

A method and system for managing messages including voice messages in a graphical user interface. One example system includes a database configured to store messages having voice messages associated therewith. The system includes a graphical user interface comprising an inbox display configured to graphically display at least a portion of the messages. The inbox display includes at least one play icon that, when selected by a user, plays a selected voice message directly within the graphical user interface. The inbox display further allows the user to manage the messages and to control playback of the voice messages directly within the graphical user interface.

### CROSS-REFERENCE TO RELATED APPLICATIONS

This application claims the benefit of U.S. Provisional Application No. 60/823,065, filed Aug. 21, 2006, which is incorporated herein by reference in its entirety.

### BACKGROUND

### Background and Relevant Art

Electronic messages (e-mails) facilitate rapid and convenient communication between two or more users. When communicating using email, it is common for a user to reply to the original sender. If more than one person received the initial email, a recipient can reply to those persons as well. Additionally, a user may forward the message to additional recipients.

A group of related messages, such as messages that include replies and/or have been forwarded to other people, are typically referred to as a thread. Email or other types of messages that are mainly text based often provide the thread information within the body of the message. A user can easily view related messages because of the thread information.

Another form of communication amongst users is voice messages and it is becoming increasingly popular to send audio or voice messages using email or other similar formats. When sending voice messages, however, it becomes much more difficult to manage the voice messages and to determine whether the voice message is part of a thread.

### BRIEF SUMMARY

A system is provided herein that includes a graphical user interface. In particular, embodiments of the invention relate to a systems and methods for managing messages including voice messages and in particular to a graphical user interface for managing messages. The graphical user interface allows a user to manage messages, including but not limited to voice messages and other audio recordings or data.

According to one example, the graphical user interface permits users to create and access and otherwise manage voice messages on a computer. The graphical user interface further allows the user to listen to a voice message directly from an entry in an inbox, including the ability to advance to a selected point in the voice message. The graphical user interface further provides a hierarchical view of individual messages in a thread of voice messages. The user is further able to interact and manage each individual message within the voice message thread. In addition, the graphical user interface provides an editable notes/subject field associated with voice messages in an inbox in which the notes can be generated automatically, edited, and forwarded to third parties.

Variations on this general approach are also illustrated. For example, in another embodiment, a method of providing voice messages on a display device is provided. The method may be practiced, for example, in a computer system including a display device and a user interface selection device. The method includes retrieving messages for a user, each message associated with a voice message. The messages are displayed in a list within a graphical user interface screen, as well as play icons adjacent to each of the messages. Upon receiving a message selection signal from a user pointing at one of the play icons, the method plays the voice message associated with the selected play icon directly within the graphical user interface screen.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered limiting in scope, embodiments will be described and explained with additional specificity and detail through the use of the accompanying drawings in which:

FIG. 1 illustrates a schematic view of an audio message retrieval system according to one example;

FIG. 2 illustrates a graphical user interface according to one example displaying an inbox display according to one example;

FIG. 3 illustrates a message recording display within the graphical user interface according to one example; and

FIG. 4 illustrates one example of a flow diagram for providing voice messages on a display device.

### DETAILED DESCRIPTION

Systems and methods are discussed herein for sending and receiving messages that have an audio element, such as a voice message, associated therewith. Embodiments of the invention relate to a systems and methods for managing voice messages and in particular to a graphical user interface that enables users to manage (i.e., access, create, delete, forward, move, reply, listen, etc.) voice messages on a computer.

According to one example, the graphical user interface organizes and displays the messages as entries in an inbox. Further, the graphical user interface provides a view of a voice message thread or provides a view of related voice messages. This enables a user to listen to a specific voice message in a thread. In one example, a hierarchical view of individual messages in a threaded voice message string can be displayed to a user.

According to one example, the voice message is included with the message as an attachment or may be accessed using a provided in the message. The various voice messages in the thread can also be includes as an attachment or as a link. The graphical user interface allows a user to play a voice message directly from an entry in the inbox. A user may also be able to advance to a selected point in the voice message in various ways, such as manual advancement, searching for specific words or phonemes, or time increments.

In addition, the interface may provide an editable notes/subject field associated with voice messages in the inbox, in which a notes/subject field can be generated automatically, edited, and/or forwarded to third parties. The interface further allows a user to listen to selected portions or sub-portions of a received audio or multi-media message and to forward individual portions or sub-portions of the message.

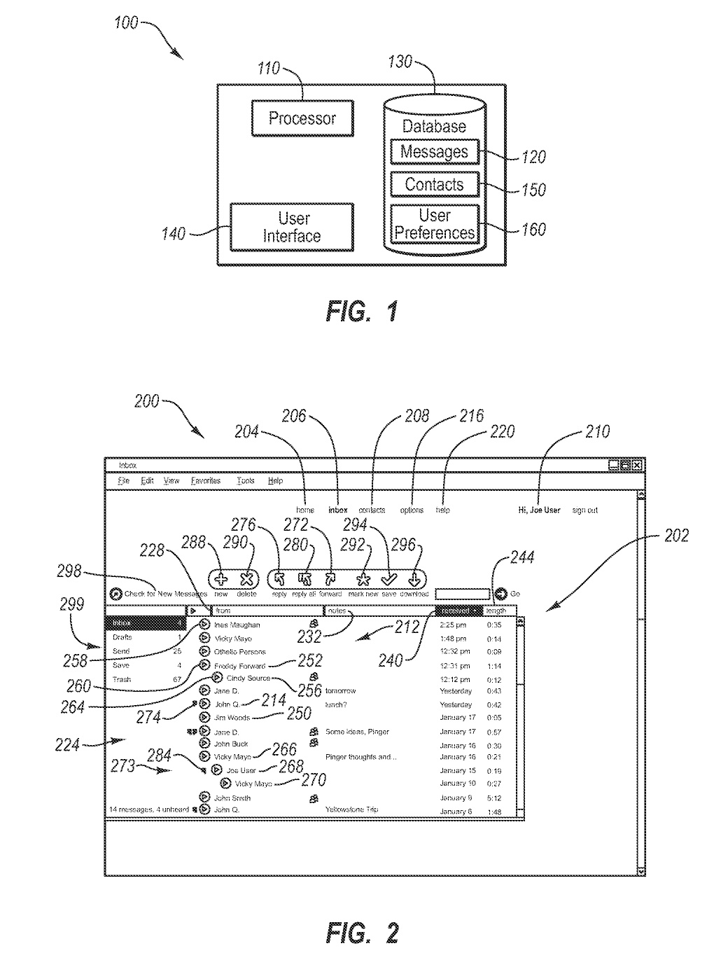

FIG. 1 illustrates a schematic view of a voice or an audio message retrieval system (100). The audio message retrieval system (100) generally includes a processor (110) and a database (130), which may reside on any computer readable medium. The database (130) can be stored on one or more servers and may be accessible over a network, such as a Local Area Network or over the Internet. A user interface (140) provides an interface for a user to interact with the processor (110) and the database (130). The user interface (140) can be part of a client and/or server based application or can be presented via a browser.

The processor (110) processes incoming data, such as voice messages (120). According to one example, incoming messages (120) are first stored in the database (130) after which the processor (110) processes the stored message (120) to form a message suitable for delivery in the same or in an alternative format. For example, the processor (110) may be configured to process a voice message (120) to be delivered using email protocol. For ease of reference, email protocol will be discussed in reference to an alternative format. In addition to storing messages, the database may also store a user's contact information (150), user preferences (160), and the like.

The combination of an email with an audio recording will be referred to generally as a message. Those of skill in the art will appreciate that other types of message delivery formats may be utilized for delivery of the voice message. Returning to the example of an email, the voice message may be included in the email as an attachment or the processor may provide a link in the email for accessing the stored voice message on the database (130).

The message (120) may include additional information about the original voice message. For example, the message (120) may include information about the sender, information related to the topic of the voice message, and/or the time the message was received by the system (100).

The system (100) may both send and receive voice messages (120) via the selected alternative format, for example, email, to and from other recipients that have access to the system or to and from recipients outside the system. The user interface (140) facilitates the managing (e.g., sending, receiving, listening, deleting, forwarding, replying, etc.) of messages (120), either within the system (100) or residing on other systems. The user interface (140) may reside on the system (100) as shown in FIG. 1. Further, the user interface (140) may display a graphical user interface on a client computer or device.

The user interface (140) organizes and displays the messages as entries in an inbox and a user can play a voice message directly from an entry in the inbox, including the ability to advance to a selected point in the voice message. The user interface (140) enables a user to play the voice message without being required to open an alternative audio or multimedia player. The user interface (140) may also provide a hierarchical view of individual messages in a threaded voice message string. In addition, the user interface (140) may be configured to provide an editable notes/subject field associated with a voice message in the inbox, in which a notes/subject field can be generated automatically or manually, edited, and forwarded to third parties. The interface (140) further allows a user to listen to selected portions or sub-portions of a received audio or multi-media message. A user can also forward individual portions or sub-portions of a message. These and further features will be discussed in more detail below.

FIG. 2 illustrates a graphical user interface (200), which is one embodiment of the graphics that may be displayed to a user by the user interface (140). The graphical user interface (200), according to the present example, is shown displaying an inbox display (202). The graphical user interface (200) includes several screen access icons, including a home screen icon (204), an inbox display icon (206), a contacts screen icon (208), an options screen icon (216), and a help screen icon (220). Each screen access icon may be selected to access a corresponding screen. For example, selecting the home screen icon (204) may present a home page user interface from which other aspects of the audio message retrieval system (100) may be accessed. Selecting the contact screen icon (208) may take a user to a graphical user interface that permits the user to manage the user's contacts. Selecting the help screen icon (220) may take the user to a help interface with links, for example, to address user concerns or user questions.

In this example, FIG. 2 illustrates a scenario in which the inbox display icon (206) has been selected, such that the inbox display (202) is shown on the graphical user interface (200). Each of the other screen access icons may similarly be activated such that a corresponding screen is displayed on the graphical user interface (200), as described above. The inbox display (202) displays messages (212) contained in an inbox to the user (i.e., owner) of the inbox. In the present example, the user's name is “Joe User” (210). The inbox display (202) displayed on the graphical user interface (200) will be discussed in the context of first receiving and accessing a message and then in the context of sending a message.

A message received by the system (100) may first be processed prior to being displayed in the inbox display (202). According to one example, processing the message may include determining the source of the message, the time the message was received, whether any topical information is associated with or may be gleaned from the message, whether the message is part of a thread of messages or otherwise includes message history information associated therewith, and the like. Processing the message may also include converting the message to a format appropriate for display in the inbox display (202).

The received message(s) are displayed in a display portion (224) of the inbox display (202). According to one example, a default setting for the display portion (224) sorts incoming messages into rows. In particular, as seen in FIG. 2, messages may be sorted chronologically, with newer messages listed near the top of the display portion (224) and progressively older message listed in order downward. The messages may be sorted in any order, including listing the newer messages near the bottom of the display portion, or by sorting the messages by source (228), subject or notes (232), time received (240), length (244), or any other sorting criteria. For ease of reference, the messages will be discussed as being sorted by time received (240), with the newer entries being listed above older entries.

The display portion (224) is further organized into columns in this example. Each column includes specific information, if available, about each message. These columns include a source column (228), a notes column (232), a time received column (240), and a length column (244). The notes column (232) includes information related to the voice message. Entries in the notes column may include information that has been selectively extracted by the system (100) as will be discussed in more detail below. The entry may also or alternatively include information entered by the sender or source of the message. An incoming message is processed and relevant information is sorted and listed in the corresponding columns within the message display portion (224) of the graphical user interface (200).

The illustrated graphical user interface 200 further organizes the source column (228) in a hierarchal manner to provide readily identifiable information as to a given message, such as the previous sources, recipients, responses, and the associated with a given message. The source column (228) displays a main or primary message source on a first line. The main or primary source identifies the person who sent the message to the user (210). If the message is not part of a thread, but is a standalone message composed and sent by the sender to the user (210), the identity of the sender is the only item listed in the source column (228). Such an example is seen in a message (250) sent by Jim Woods.

If, however, the message is part of a forwarded message thread, the history information related to the other portions of the thread may also be included in the source column (228) and sorted hierarchically. For example, a message (252) from “Freddy Forward” is part of a thread. In the present scenario, an original message (256) from Cindy Source was sent to Freddy Forward. Freddy Forward in turn recorded an introduction to the original message (256), and then forwarded the resultant message (252) to the user (210).

The graphical user interface (200) may indicate that Cindy's message was forwarded by Freddy by listing Freddy Forward's message entry (252) in the source column (228) on a row above Cindy Source's original message entry (256). Cindy Source's name or other identifying information and the original message (256) is listed on a row below Freddy Forward's message (252) as a second entry. According to the present example, Cindy Source's name may be indented to identify the original message (256) as being a sub-portion or sub-message of the message sent by Freddy Forward.

If, for example, the Cindy Source message (256) had included additional message recordings that were sent to her and which she had subsequently forwarded to Freddy Forward, those messages would also be identified as part of the message thread by including the source of the messages, if known, and indenting the source information relative to at least the first row for the message entry (252). Accordingly, the graphical user interface (200) provides a hierarchical organization for messages that include an audio component.

The graphical user interface (200) allows the user (210) to listen to the message content directly from the inbox display (202). Rather than being required to save the audio recording and manually open the audio recording with another audio or media player, the user (210) can simply play the message directly from the user interface 200. For example, each message (212) may be associated with a play icon (258). By clicking one of the play icons (258), the corresponding audio recording is played directly within the user interface (200) rather than causing a separate audio or media player to be opened in order to play the audio recording.

The graphical user interface (200) allows the user (210) to readily select the portions of the message that the user wishes to hear. For example, using the forwarding example of Cindy Source (256) and Freddy Forward (252), the graphical user interface (200) includes a primary play icon (260) with the message entry (252) and a secondary play icon (264) with each of the subsequent lines, such as with the original message (256). According to one example, selecting the primary play icon (260) plays the recording sent by the primary source. In the scenario discussed above, selecting the primary play icon (260) would play the message recorded by Freddy Forward. Thereafter, the user (210) would be able to listen to any secondary message by selecting the corresponding secondary play icon (264). Continuing with the Freddy Forward/Cindy Source example, selecting the secondary play icon (264) would play the original message (256). Thus, the graphical user interface (200) allows the user (210) to listen to any portion of the message thread while allowing the user to choose how messages are sorted and how the audio portion of the message is played.

Furthermore, where multiple messages are part of a single voice message thread, in one embodiment, by selecting to play one voice message, the user interface (200) may first play the selected message and may then automatically play one or more of the other voice messages within the thread. For example, continuing with the Cindy Source (256) and Freddy Forward (252) example, by selecting to play the Freddy Forward message, the graphical user interface (200) may play a message left by Freddy Forward, and then may automatically play the message left by Cindy Source.

Further, a user (210) can listen to specific portions of a message. When selecting the portion sent by Cindy Source, a user (210) may choose to start at any point in the message. For example, when a user (210) initiates the playback of a message, for example, by clicking a play icon (258), a graphic may be displayed to the user indicating a timeline of the audio recording. The timeline may be controlled by the user (210) so that the user can quickly position the playback feature at any point within the timeline of the audio recording.

FIG. 2 also illustrates one example of a hierarchical organization technique for a message thread including one or more reply messages. In particular, message thread (273) illustrates a situation in which Vicky Mayo has sent a message (270) to the user of the example inbox (202), named Joe User (210). Thereafter, Joe User sent a reply message (268) to Vicky Mayo. Joe's reply (268) may be indicated by a reply icon, such as an arrow (284). Thereafter, Vicky Mayo sent a reply message (266) to Joe User. According to the present example, the user (210) is able to listen to the most recent message sent from Vicky Mayo (266), his reply message (268) and Vicky Mayo's original message (270).

In one embodiment, the messages (212) displayed by the graphical user interface (200) can also be accessed via a telephone. In other words, rather than accessing the messages (212) by opening the graphical user interface (200), the user can access the messages (212) by calling into the message system (100) and selecting individual messages via a touchtone or voice recognition interface. When a user accesses voice messages 212 via a telephone interface, the ability to generate voice message threads as disclosed above provides a listener with the context of each message that would not otherwise be available.

For example, when the user (210) listens via a telephone interface to a message (266) that is in reply to the message (268) originally sent by the user, the system may also play the user's original message (268) either immediately after or before playing the reply message (266). Therefore, if the user (210) sends Vicky Mayo a first message regarding a first task that Vicky is responsible for and a second message regarding a second task that Vicky is responsible for, by using threading, Vicky can reply by simply stating “Done.” By listening to the entire threads, the user (210) can easily determine task Vicky Mayo is referring to.

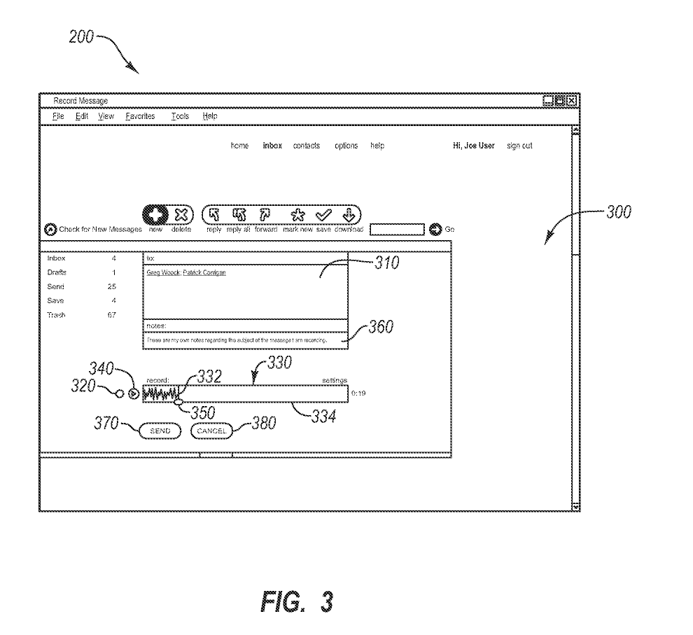

Referring now to FIG. 3, an example message recording display, denoted generally at (300), is provided. The message recording display (300) includes a recording viewer (330). The illustrated recording viewer (330) may graphically display the voice sound wave pattern (332) of the user along a time line (334) as the message is recorded. In one embodiment, a user may record a message via a microphone attached to or integrated within the user's computer. The user may record a message by selecting the record icon (320), speaking into the microphone, and selecting the record icon (320) again to complete the message. Thereafter, the user may review the message.

To review the message, the user may select a play icon (340). By default, the play icon (340) may initially begin the playback of the message from the beginning. Alternatively, the user may access any point of time within the message with the use of a slider (350). In particular, the location of the slider (350) is correlated to the time line (334) and the recording viewer (330). By dragging the slider (350) to a desired location along the time line (334), the user is thereby able to access the recording at that point of the message. The graphical representation of the voice sound wave pattern (332) may provide visual clues to assist the user when selecting a starting point within the message.

In addition to allowing the user to review the recorded message, in one embodiment, the message recording display (300) allows the user to edit the message. For example, in one embodiment, the user can rerecord part or the entire message from a selected point. The user may find the desired point by dragging the slider (350) to estimate the location and then listen to message to determine if the desired point has been reached. Once the desired point in the message has been reached, whether at the beginning of the message or some other point, the user may then select the record icon (330) and rerecord the message from that point.

The example message recording display (300) also allows the user to enter notes using a note entry box (360). To enter notes, the user selects the note entry box (360) and inputs notes or any other desired information. When the message is sent, the notes may also be sent to be read by the recipient. In one embodiment, the notes may be treated as a subject line for allowing the recipient to quickly determine the subject matter of the recorded message.

Once the user completes the message, the user may send the message by selecting a send icon (370). The send icon (370) causes the system to send the message to the recipients indicated in the recipient entry box (310). Alternatively, if the user decides not to send the message, the user may select a cancel icon (380). According to one example, if the message is sent or the action is cancelled the user is returned to the previous screen, such as the inbox display (202) shown in FIG. 2.

The graphical user interface (200) also allows the user (210) to manage how the messages (212) are treated within the system as well as managing outgoing messages. The management of outgoing messages, including forwarding and replying to messages will now be discussed, followed by a discussion of drafting new messages. Thereafter, the handling of messages within the system will be discussed.

Referring again to FIG. 2, the illustrated graphical user interface (200) includes a forward icon (272), a reply icon (276), and a reply to all icon (280). Each of these icons may be used to interact with a message (212) that has already been received. For example, the forward icon (272) allows the user (210) to send a message (212) in the inbox to another recipient. Further, the forward icon (272) allows the user (210) to send any or all of the audio recording associated with any message (212). For example, returning to the message (252) from Freddy Forward, the user (210) is able to send the entire message (252), or any of the messages within the thread. In this situation, the user (210) may be allowed to select whether to send the entire message (252), which includes the audio recording recorded by Freddy Forward, the original message (256) recorded by Cindy Source, or both messages. In one embodiment, to forward the entire message (252), the user may highlight the entry in the thread and then select the forward icon (272). In one embodiment, if the user forwards a message, such as message (214), a forwarded icon (274) is displayed adjacent to the message (214) that was forwarded.

Selecting the forward icon (272) may access the message recording display (300), as described in FIG. 3. When the forward icon (272) is selected, the selected recorded message or desired portions thereof are attached to or included in the message being composed. In order to forward a message, the user may select the desired recipient or recipients by entering their contact information in a recipient entry box (310). The user then has the option of recording a message to accompany the forwarded message. According to one example, the user records a message by selecting the record icon (320) and vocalizing the message.

Referring again to FIG. 2, in addition to allowing a user to forward a message, the graphical user interface (200) allows the user to reply to the sender and/or to others who received a given message. As previously introduced, the graphical user interface (200) includes the reply icon (276) and the reply to all icon (280). Selecting either of these icons (276, 280) causes the message recording display (300; FIG. 3) to be displayed and automatically inputs the corresponding intended recipient or recipients' information in the recipient entry box (310). Thereafter, the user is able to record a message and/or enter notes as previously discussed. If the user replies to a message, such as message (268), a replied icon (284) may be displayed adjacent to the message to which the user replied.

The graphical user interface (200) also allows the user to create an original message by selecting a new message icon (288). Selecting the new message icon (288) causes the system to display the message recording display (300). The user is then able to record an original message and enter notes as discussed above.

Thus, the graphical user interface (200) allows a user to manage outgoing messages. As previously introduced, the graphical user interface (200) also allows a user to manage the handling of messages within the system. For example, the graphical user interface (200) may include a delete message icon (290). Choosing the delete message icon (290) deletes a selected message. Additional icons may include, without limitation, a mark as new icon (292), a save message icon (294), a download message icon (296), and a check messages icon (298).

The text of each entry may be selectively formatted or otherwise distinguished to identify the entry as either new or read. According to one example, new messages are listed in bold text while read messages are listed in non-bold text. The mark as new icon (292) formats the text associated with the selected entry to appear as unread or new. The save message icon (294), the download message icon (296), and the check messages icon (298) help manage the interaction between the user interface (200) and the database (130; FIG. 1). In particular, choosing the save message icon (294) may cause the system (100; FIG. 1) to identify the message so that the message will be saved long-term. The download message icon (296) allows the user to download the message to a selected location. For example, if the user interface (200) is operating on a client computer, choosing the download message icon (296) may cause the system (100; FIG. 1) to download and save the message locally to the client device. The check messages icon (298) checks the system for any new messages that may have been delivered for the user.

While the inbox display (202) is displayed on the example graphical user interface (200), an inbox view selection menu (299) may also be displayed. The inbox view selection menu (299) allows a user to select which aspect of the mailbox she wishes to view. According to one example, an inbox is displayed by default. However, the mail box view selection menu (299) also allows the user to view other aspects of the inbox display (202), including drafts of messages, messages that the user has sent, messages the user has saved, and/or messages that the user has selected for deletion.

In addition to allowing a user to view and manage messages, including threaded messages having audio recordings, the illustrated graphical user interface (200) may be configured to display notes (232) that may be extracted from the audio recordings by using speech analysis.

For example, and according to an embodiment of the invention, the processor (110) may further be configured to utilize a speech analysis engine to perform data analysis of the recipient's voice messages in order to generate topic data containing key words and phrases describing the content of the voice messages. Details of the methods for performing data analysis on the recipient's voice messages in this manner are set forth in U.S. Provisional Patent Application Ser. No. 60/199,978, filed May 12, 2006, which is incorporated herein by reference.

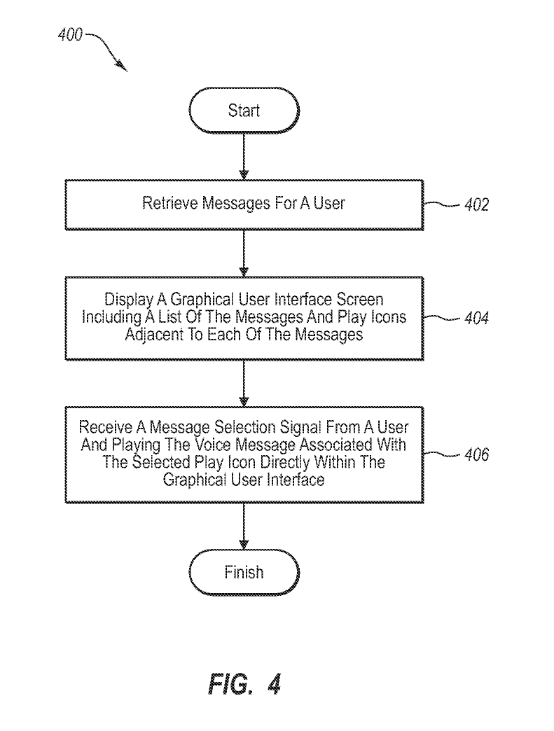

FIG. 4 illustrates one embodiment of an aspect of a method 400 that can be used for providing voice messages on the display device, shown generally from the perspective of a graphical user interface. The method 400 may be practiced, for example, in a computer system including a display device and a user interface selection device. The method 400, beginning at 402, includes retrieving messages for a user. As described previously, each of the retrieved messages is associated with a voice message.

The method 400 further includes, at 404, displaying a graphical user interface screen including a list of at least a portion of the messages and play icons adjacent to each of the messages on the display device. In one embodiment, displaying the graphical user interface screen further includes displaying the messages in a hierarchical manner for providing threaded voice message strings. In another embodiment, displaying the graphical user interface screen also includes displaying notes that are associated with at least a portion of the messages. As described previously, the notes may include text data, for example, describing the subject matter of the voice messages with which the notes are associated.

The method also receives a message selection signal from a user pointing at one of the play icons, as denoted at 400. In response to the message selection signal, the method plays the voice message associated with the selected play icon directly within the graphical user interface screen. The method 400 may further allow a user to select a starting point for playing the message. For example, the method may include receiving a message positioning signal from the user, wherein the method positions the voice message at a selected point to allow the user to listen to the voice message from the selected point. In one embodiment, where the message selected by the user is included within a threaded voice message string, the method may play the voice message associated with the selected play icon and also play at least one of the other messages within the threaded voice message string. By playing multiple messages within the threaded voice message string, the user is provided with additional context for the selected message.

In one embodiment, the method 400 may include receiving a message creation signal from the user. Upon receiving the message creation signal, the method 400 may include displaying a message recording display within the graphical user interface, such as the message recording display illustrated in FIG. 3. The Message recording display may include a record icon, a timeline and a slider, and may allow the user to create, review, edit, and send a new voice message to at least one recipient directly within the graphical user interface. In other words, the user is not required to record a voice message using a separate recording software program. Upon receiving a record signal from the user, the method may include recording audio received from the user and displaying a sound wave pattern display adjacent to the timeline for providing a visual depiction of the recorded audio. In addition to recording a new voice message, the message recording display may also collect text data from the user, which will be associated the text data with the new voice message.

Embodiments herein may comprise a special purpose or general-purpose computer including various computer hardware, as discussed in greater detail below. Embodiments may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The following claims are presented to illustrate various novel features of the present invention. The claims are not exhaustive of the embodiments of the invention, nor are they to be construed as limiting the scope of the invention. Moreover, the invention disclosed in detail herein can be defined with other claims, including those that will be included in any related non-provisional applications that will be filed during the pendency of this provisional application.

What is claimed is:

1. A system for managing voice messages, the system comprising:
a database configured to store messages having voice messages associated therewith; and
a graphical user interface comprising an inbox display configured to graphically display at least a portion of the messages, the inbox display including at least one play icon that when selected by a user, plays a selected voice message directly within the graphical user interface, the inbox display further configured to allow the user to manage the messages and to control playback of the voice messages directly within the graphical user interface.

2. The system of claim 1, wherein the graphical user interface is further configured to organize the messages hierarchically for providing threaded voice message strings.

3. The system of claim 2, wherein the threaded voice message strings include at least one of a parent voice message, a reply voice message and a forwarded voice message.

4. The system of claim 2, wherein the graphical user interface is further configured such that upon receiving a selection from a user to play one of the voice messages within one of the threaded voice message strings, the user interface plays the selected voice message and at least one other message within the threaded voice message string.

5. The system of claim 1, wherein the graphical user interface further comprises a message recording display configured to allow the user to create, review, edit, and send a new voice message to at least one recipient directly within the graphical user interface.

6. The system of claim 5, wherein the message recording display is further configured to allow a user to generate a voice message and text data.

7. The system of claim 5, wherein the graphical user interface is further configured to allow the user to forward one of the voice messages to the at least one recipient, and wherein the message recording display is further configured to allow the user to select to forward all or part of the voice message being forwarded.

8. The system of claim 5, wherein the message recording display comprises a timeline and a slider for allowing a user to advance to a selected point in the new voice message, and further comprising a sound wave pattern display adjacent to the timeline for providing a visual depiction of the new voice message.

9. The system of claim 1, wherein the inbox display is further configured to allow the user to advance to a selected point in the voice message to listen to the voice message from the selected point.

10. The system of claim 1, wherein the inbox display includes a separate play icon for each voice message, wherein the play icons are located adjacent to each voice message.

11. The system of claim 1, wherein the inbox display further includes a reply icon for allowing the user to create a new voice message reply to one of the voice messages displayed within the inbox display directly within the graphical user interface.

12. In a computer system including a display device and a user interface selection device, a method of providing voice messages on the display device, the method comprising:
retrieving messages for a user, each message associated with a voice message;
displaying a graphical user interface screen including a list of at least a portion of the messages and a plurality of play icons adjacent to each of the messages on the display device;
receiving a message selection signal from a user pointing at one of the play icons, and, in response to the message selection signal, playing the voice message associated with the selected play icon directly within the graphical user interface screen.

13. The method of claim 12, wherein displaying a graphical user interface screen further comprises displaying the messages in a hierarchical manner for providing threaded voice message strings.

14. The method of claim 12, wherein receiving a message selection signal further comprises receiving a message selection signal from the user pointing at a play icon associated with a message within one of the threaded voice message strings, and, in response to the message selection signal, playing the voice message associated with the selected play icon and at least one other message within the threaded voice message string.

15. The method of claim 12, further comprising receiving a message creation signal from the user selecting a create message icon, and, in response to the message creation signal, displaying a message recording display within the graphical user interface, the message recording display including a record icon, a timeline and a slider, the message recording display configured to allow the user to create, review, edit, and send a new voice message to at least one recipient directly within the graphical user interface.

16. The method of claim 15, further comprising receiving a record signal from the user selecting the record icon, and, in response to the record signal, recording audio received from the user and displaying a sound wave pattern display adjacent to the timeline for providing a visual depiction of the recorded audio.

17. The method of claim 15, further comprising receiving text data from the user and associating the text data with the new voice message.

18. The method of claim 12, further comprising receiving a message positioning signal from the user, and, in response to the message positioning signal, positioning the voice message at a selected point to allow the user to listen to the voice message from the selected point.

19. The method of claim 12, wherein displaying a graphical user interface screen further comprises displaying notes with at least a portion of the messages, the notes including text data associated with the voice messages.
